(19) United States
(12) Patent Application Publication
(10) Pub. No.: US 2016/0116639 A1
(43) Pub. Date: Apr. 28, 2016

(54) APPARATUS, SYSTEM AND METHOD TO MITIGATE RISK OF ADVERSE OPERATIONAL ENVIRONMENTAL EFFECTS

(71) Applicant: Alexander J. Engell, Bozeman, MT (US)

(72) Inventor: Alexander J. Engell, Bozeman, MT (US)

(21) Appl. No.: 14/523,613

(22) Filed: Oct. 24, 2014

(51) Int. Cl. G01W 1/10

(52) U.S. Cl. CPC G01W 1/10

(57) ABSTRACT

A system for in-situ forecasting including a first vehicle including a measuring device recording weather data correlating to an external environmental condition of interest, a storage device on the first vehicle in which the weather data is received, the storage device being operatively connected to the measuring device, a processor on the first vehicle, the processor operatively connected to the storage device, the processor accessing an automatic detection algorithm to generate environmental event condition data to be stored on the storage device, a forecast algorithm accessed by the processor wherein the processor accesses the environmental event condition data for use in the forecast algorithm, a forecast created by the processor, the processor accessing the forecast algorithm and wherein the forecast is stored on the storage device, and a risk mitigation instruction created by the processor wherein the risk mitigation instruction in based on the forecast.

### FIELD OF THE INVENTION

The present invention relates generally to an apparatus, system and method of mitigating the risks associated with adverse operational environmental conditions which may change rapidly. More particularly, though not exclusively, the present invention relates to an apparatus, system and method of mitigating the risks associated with adverse operational environmental conditions by performing forecasting at the site of interest and subsequently taking actions based on anticipated environmental changes.

### Problems in the Art

Currently, it is well known that adverse environmental conditions can occur rapidly and, at the same time, that with enough advance warning, many of the risks associated with adverse environmental conditions can be avoided or lessened. Solar flares and other solar activity can disrupt spacecraft performance, cause damage to semi-conductor based electronic systems, whether terrestrial or space based. Ionizing radiation associated with solar eruptions increases health risk to high-polar route flight passengers and astronauts. Signal disruption is also a problem created by adverse environmental conditions. For example, GPS satellites are very sensitive to space weather disturbances. Other communications systems which rely on low frequency signals, can also be disturbed. Electrical power companies can also be affected, particularly with transformers. The events forecasted are usually classified as low-frequency high-risk events. If a large space weather event occurs much of the technological world will be affected. Lloyd's estimated that a Carrington-like event would cost the eastern US power grid on order of $2-3 trillion. Between 1996-2006 it is estimated that the US lost $2-3 billion per year due solar storms affecting the power grids alone. It is also estimated the satellite industry would lose $30 billion.

Systems such as those described in U.S. Pat. No. 7,096,121, which is incorporated in its entirety herein by reference, are used to forecast environmental changes on space-based systems, using historical data and observational data gathered remotely. These systems compile data and perform predictive analysis at a centralized location, remote from the spacecraft, aircraft, or land based vehicle or location which will ultimately rely on the forecasts. Ironically, such remotely calculated forecasting systems rely on a notification that must then be transmitted to the system of interest and this system must then use the notification or rely on another remotely based controller to take corrective action to mitigate the forecasted environmental changes. The transmission of the forecasts and notification/mitigation instructions must rely on clean and timely transmissions and these transmissions can themselves be adversely impacted by environmental changes, making reliability an issue. Further, the transmission delay may sometimes be significant enough to prevent or lessen the opportunity to address incoming adverse environmental conditions.

Current forecasts are improving as knowledge of environmental conditions improves. Typically, forecasting improvements are relying more and more on locally gathered data. Aircraft can fly into storms to measure wind speeds, temperatures and pressures. Seismic monitors have been placed across the globe to measure more and more movements of the earth's crust. Even satellites and other spacecraft have been sent with detectors and other sensors to measure relevant environmental data in and from space. For example, space based systems, such as those discussed in U.S. Pat. No. 8,193,968 can measure a condition of interest and the relative position of the spacecraft.

While forecasting models and data gathering are both improving, neither provides the ability for a system to independently measure, predict and act. Most current notification and automated action systems, such autopilot systems are purely reactionary, based on environmental changes that have already occurred. It is therefore desirable to have an apparatus, system or method that allows for in situ predictive capabilities that permit better risk mitigation actions both locally to the system and to remote locations that the apparatus or system can transmit.

### SUMMARY

Therefore, it is a primary object, feature, or advantage of the present invention to improve over the state of the art.

It is a further object, feature, or advantage of the present invention to enable an apparatus, system and method of mitigating the risks associated with adverse operational environmental conditions by performing forecasting at the site of interest. For example, the forecasts can cover the whole spectrum of space weather events, including: X-ray events (solar flares), particle events (radiation), and CMEs (geomagnetically induced currents (GICs)).

Another object, feature, or advantage of the present invention is to provide an apparatus, system and method of mitigating the risks associated with adverse operational environmental conditions by performing forecasting at the site of interest and subsequently taking actions based on anticipated environmental changes which can be dependent on local data gathering.

Yet another object, feature, or advantage of the present invention is to provide an apparatus, system and method of mitigating the risks associated with adverse operational environmental conditions by performing forecasting at the site of interest and subsequently taking actions based on anticipated environmental changes which is independent from external forecasting.

One or more of these and/or other objects, features, or advantages of the present invention will become apparent from the specification and claims that follow. No single embodiment of the present invention need exhibit all objects, feature, or advantages of the present invention.

A system for in-situ forecasting is accordingly provided, the system comprising a first vehicle including a measuring device recording weather data correlating to an external environmental condition of interest, a storage device on the first vehicle in which the weather data is received, the storage device being operatively connected to the measuring device, a processor on the first vehicle, the processor operatively connected to the storage device, the processor accessing an automatic detection algorithm to generate environmental event condition data to be stored on the storage device, a forecast algorithm accessed by the processor wherein the processor accesses the environmental event condition data for use in the forecast algorithm, a forecast created by the processor, the processor accessing the forecast algorithm and wherein the forecast is stored on the storage device, and a risk mitigation instruction created by the processor wherein the risk mitigation instruction in based on the forecast. A transceiver on the first vehicle can be provided for communication with a second vehicle. In this manner, a copy of the risk mitigation instruction can be sent to the second vehicle. A ground station and a copy of the weather data can be sent to the ground station through the transceiver so that a second forecast can be created at the ground station, the second forecast based on the same data used by the first vehicle to create the forecast so that a verification event occurs wherein the forecast is compared to the second forecast.

### BRIEF DESCRIPTION OF THE DRAWINGS

FIG. 1 illustrates an exemplary embodiment of a spacecraft based system according to the present invention.

FIG. 2 illustrates an exemplary embodiment of some of the instrumentation which could typically be found on a spacecraft based system according to the present invention.

FIG. 3. illustrates an exemplary embodiment of one type of remote sensing using image based data collection according to the present invention.

FIGS. 4A and B illustrate an exemplary embodiment of additional in-situ data collection according to the present invention.

### DETAILED DESCRIPTION OF THE PREFERRED EMBODIMENT

The present invention will be described as it applies to its preferred embodiment. It is not intended that the present invention be limited to the described embodiment. It is intended that the invention cover all modifications and alternatives which may be included within the spirit and scope of the invention.

The present invention generally includes an apparatus 10 on which forecasts 12 can be created, received, stored and transmitted. Additional equipment 14 on the apparatus will also include equipment to detect 16 one or more environmental conditions 18, equipment 20 to incorporate the data 22 sensed relating to that environmental condition 18 into a forecast 12, and equipment 24 to store, transmit or use the current forecast 18 to reduce the impact of upcoming environmental changes. For example, software 26 of a forecast model 28 can be uploaded to an operational piece of equipment 10 such as a power grid controller, an aircraft, spacecraft or a seismic station. Due to the small size of algorithms, they can easily be allocated onboard without taking away from much of the data storage and memory. The equipment 16 at the desired location is able to measure a physical parameter such as a geomagnetically induced current, a radiation environment such as one exposed to particles and photons, electromagnetic fields, Richter scale measurements or other physical parameters.

With such equipment 16 locally available, these one or more physical parameters or environmental conditions 18 can be measured in real time and data 22 is created from these measurements. Such data 22 is then used to create a forecast 12 using the forecasting model(s) 28 in the software 26.

Adverse forecasts 12 can be shared with other equipment 30 in the general area or transmitted to a remote location for notifications. Preferably, locally created adverse forecasts 12 electronically trigger either automatic operational changes or human notifications. For example, a satellite 10 detecting an incoming solar flare 18 or other adverse solar activity can shut down or go into a safety mode to protect sensitive equipment, current loads in a power grid can be reduced, or aircraft can be rerouted to new altitudes or in new directions. Preferably, the system 10 of the present invention can also provide notifications outside of its local area to notify other equipment 30 which lacks in-situ forecasting ability or to provide human notifications. For example, an adverse forecast 12 can automatically trigger a noise or visual alarm to tell humans to seek shelter and this alarm message can be sent to other locations deemed to be in the path of the incoming adverse conditions 18.

Forecasts 12 need to be disseminated as quickly and as effectively as possible in order for risk mitigation to be optimized. The present invention ensures this by coupling the forecasting system 32 with the systems originally used to obtain the measurements that form the inputs for the forecast model algorithm 34. In this manner, the present invention minimizes the delay in receiving remote adverse forecasts 12 and optimizes the time to take actions to minimize potential impact from an adverse weather event 18. Absent the present invention, astronauts on the way to Mars would have to wait to receive a solar radiation forecast from Earth, which could significantly impact their ability to timely take shelter or position sensitive equipment so as to reduce harmful effects. With the present invention onboard, the risks associated with an adverse environmental event which can be forecast can be more effectively mitigated.

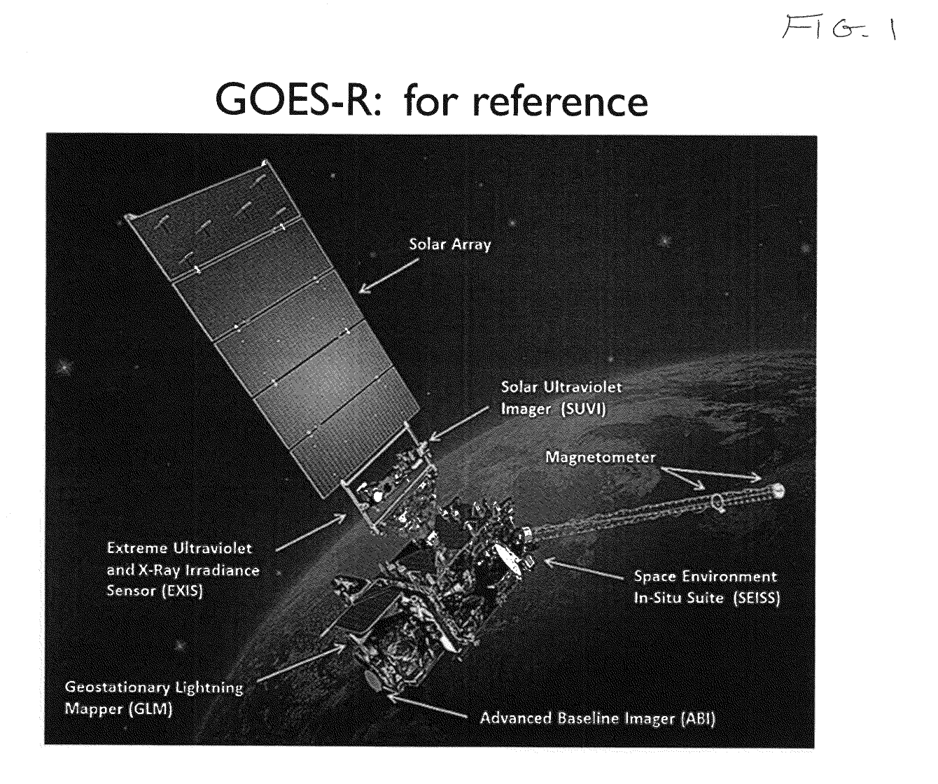

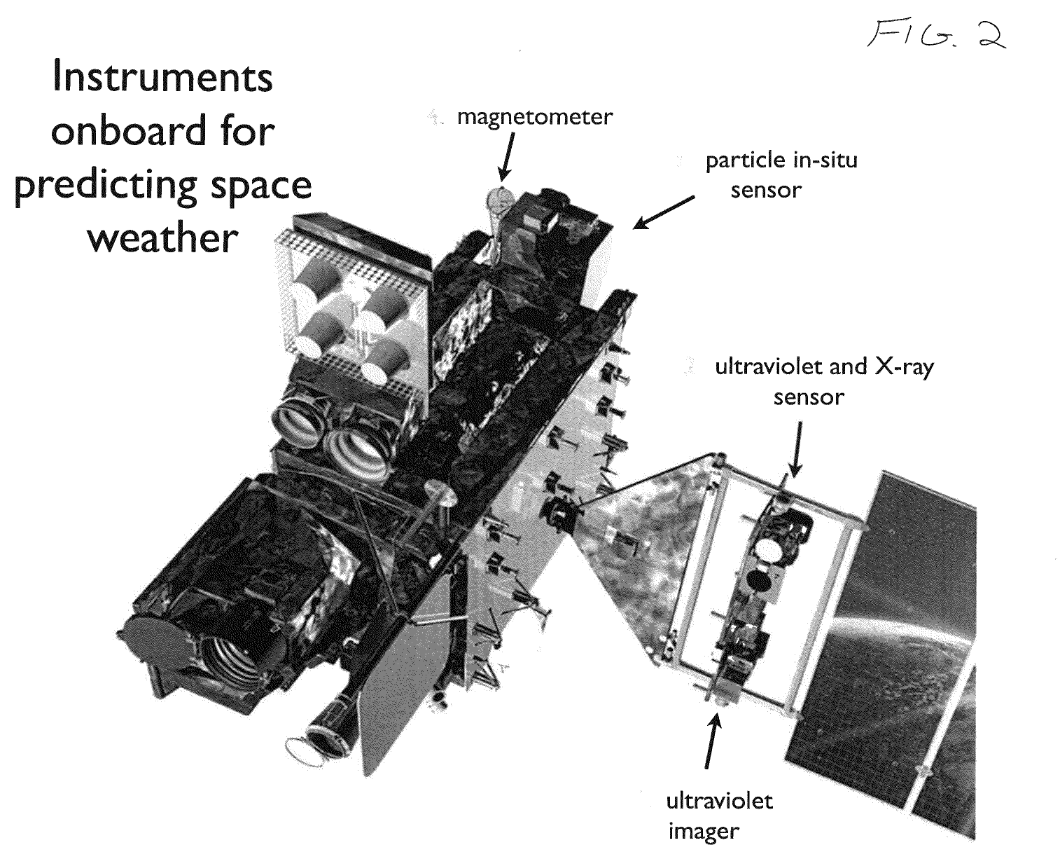

Focusing on one example which is an embodiment, but not the exclusive embodiment of the invention, space weather is likely the most transparent because the effects are usually felt globally and require spacecraft technologies. As shown in FIG. 1, automatic space weather event detection algorithms 36 are uploaded to the GOES-R spacecraft 10 (pre or post launch) and stored on a computer 20. Space weather forecasting/predicting algorithms 34 are also uploaded to the GOES-R spacecraft 10 to be used by the computer 20. The GOES-R spacecraft 10 is typical of a spacecraft embodiment of the present invention and includes a solar array 38 or other power source for various onboard instrumentation and systems 14. Such systems 14 can include many types of data collection instrumentation 16, such as a solar ultraviolet imager 40, extreme ultraviolet and x-ray irradiance sensors 42, particle sensors 44, a magnetometer 46, a geostationary lighting mapper 48 or an advanced baseline imager 50, examples of which are shown in FIG. 2.

Preferably, the computer 20 includes a space environment in-situ suite to allow for onboard forecasting using algorithms 34, 36 located and stored onboard or uploaded as desired through the spacecraft's transceivers 54. Once onboard, such algorithms 34, 36 are placed into data storage 24 or memory chips operatively connected to the space environment in-situ suite computer 20. The space environment in-situ suite computer 20 also preferably includes one or more processors 56 to use the algorithms 34, 36, wherein the processors 56 are operatively linked to the power source 38 and data collection instrumentation 16. This allows the processors 56 to use the collected data 22 with the algorithms 34, 36 to create a locally generated forecast 12. The processors 56 are also operatively linked to additional memory 24 to store the locally generated forecast 12 and one or more transceivers 54 to transmit any forecasts 12 of interest, data 22 of interest or other information as desired. These transceivers 54 also allow the system 10 to receive updated forecasting algorithms 34 as well as additional data 22 from external sources 58 that may be considered in the forecasting model 28.

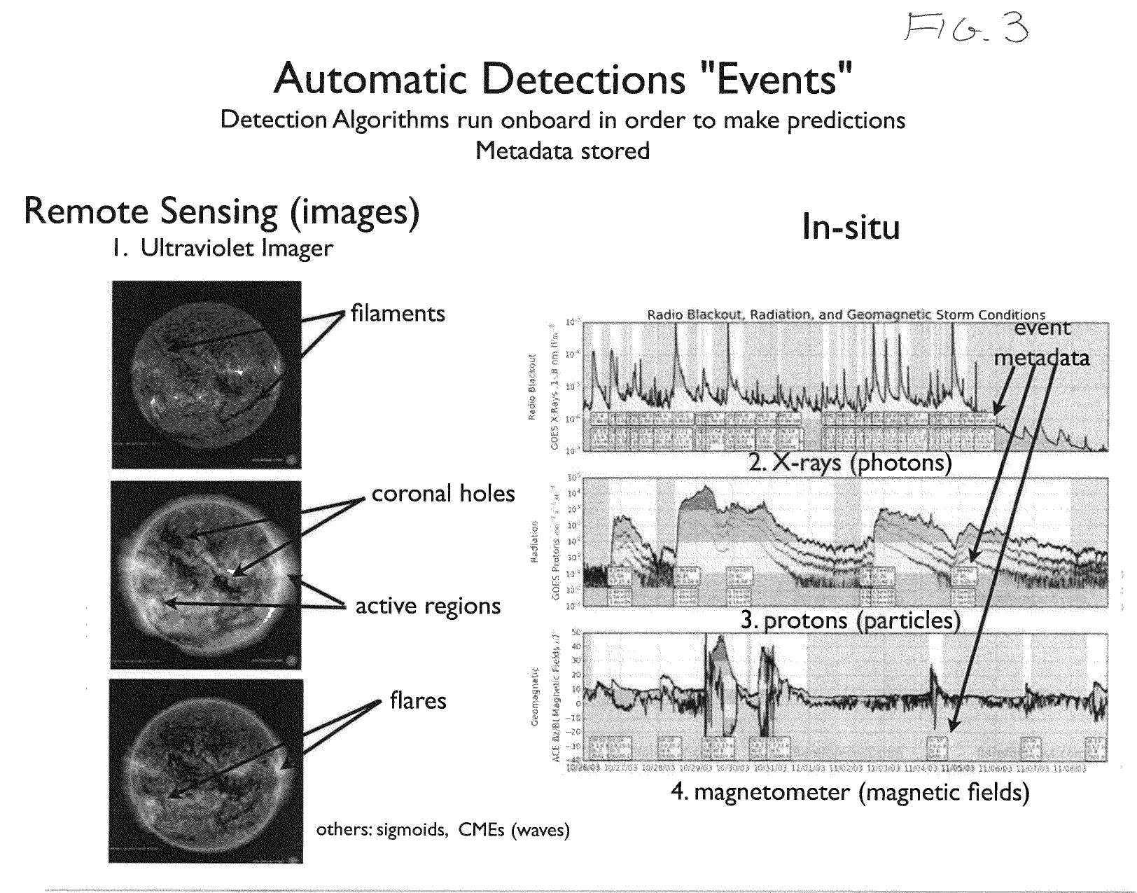

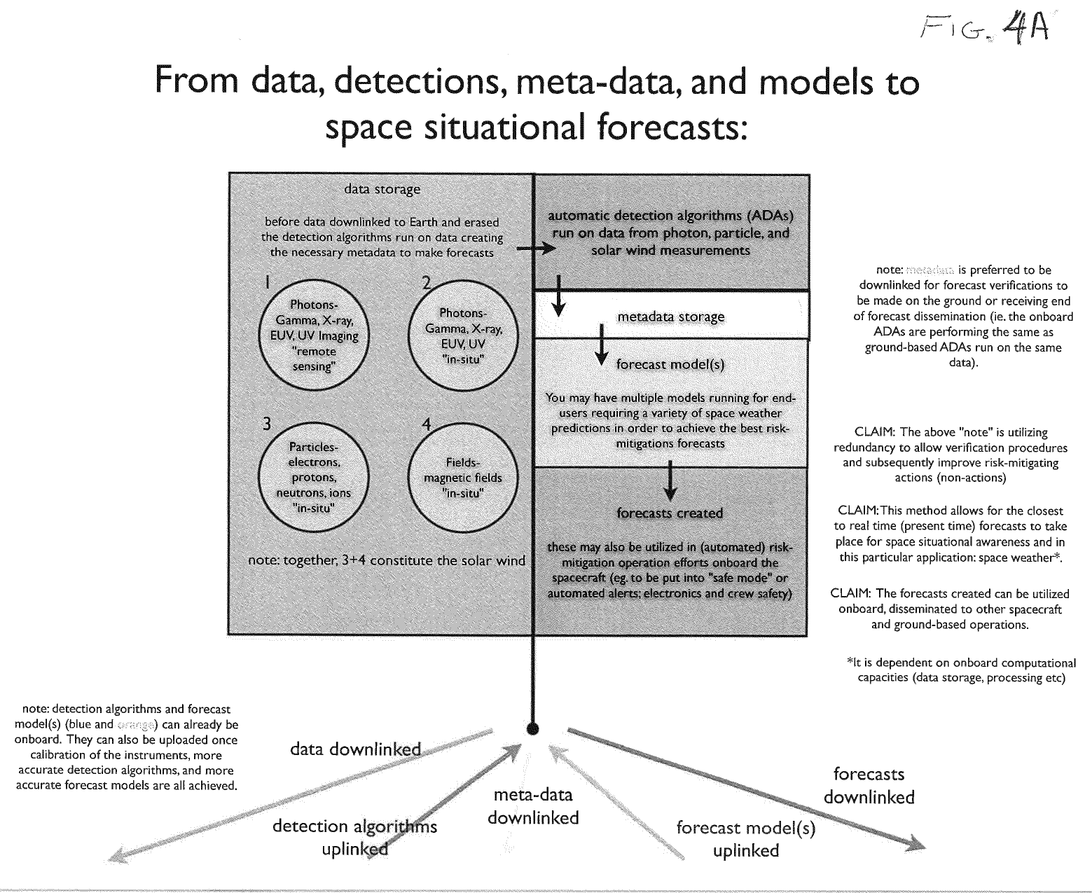

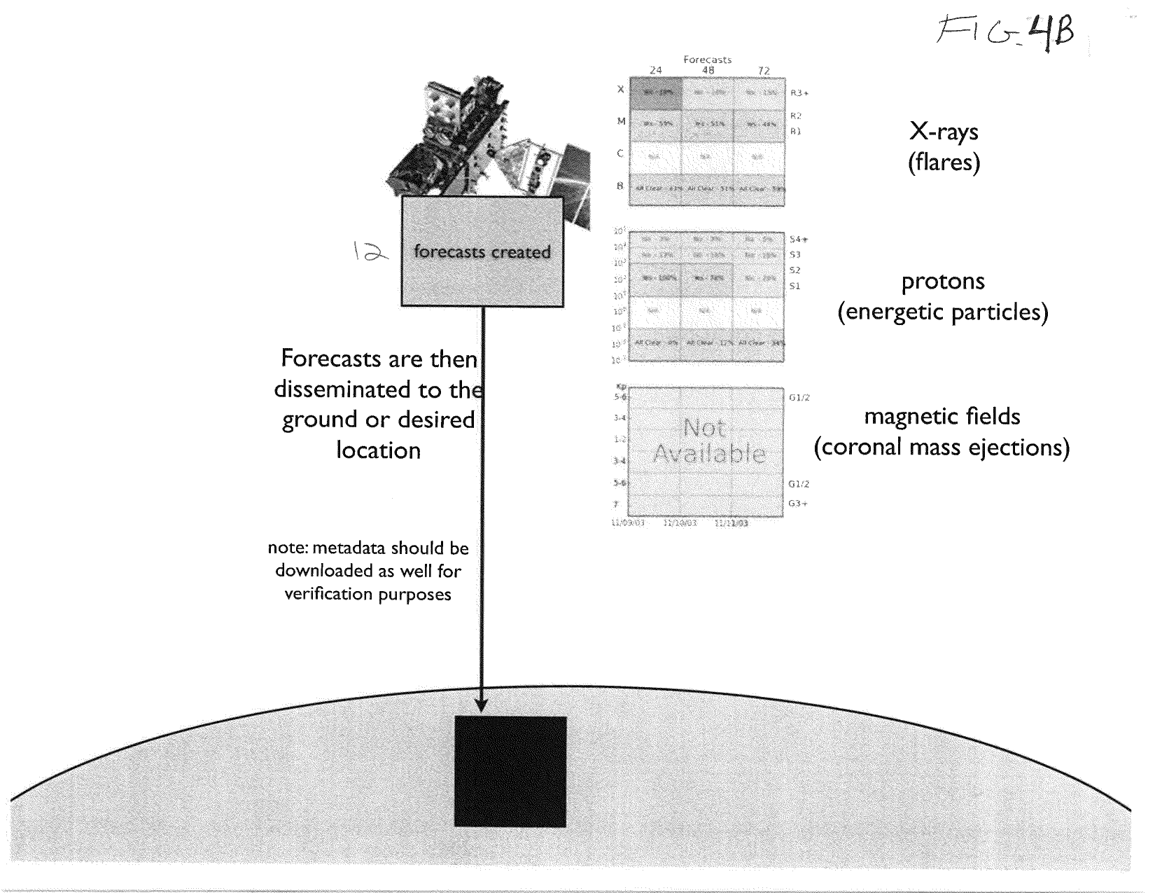

More information on the GOES-R spacecraft 10 can be found at: http://www.goes-r.gov/mission/mission.html, which is incorporated herein in its entirety by reference (GOES future missions—4 satellites: 2016-2034). The space weather event detections 60 can include, but not are not limited to run on the solar imaging as shown in FIG. 2, magnetic field, proton, and photon instruments 16, which generate data 22 that is visualized as shown in FIGS. 3 and 4. Utilizing the SUVI, instrument automatic detection algorithms 36 can extract metadata 62 on filaments, coronal holes, active regions, dimmings, and flares as discussed at http://www.goes-r.gov/spacesegment/suvi.html. Utilizing the MAG instrument automatic detection algorithms 36 will extract information on coronal mass ejections' (CMEs) magnetic fields. http://www.goes-r.gov/spacesegment/mag.html. Utilizing the SEISS instrument automatic detection algorithms 36 will extract information on incoming protons and electrons (radiation events). http://www.goes-r.gov/spacesegment/seiss.html. Utilizing the EXIS instrument automatic detection algorithms 36 will extract information on the Sun's X-ray and EUV output. http://www.goes-r.gov/spacesegment/seiss.html.

Based on the benchmarked metadata an algorithm 34 desired for space weather event prediction is developed. Preferably, this algorithm 34 is then uploaded to the spacecraft 10 and integrated to all of the event detection algorithms 36 that are needed to produce the prediction/forecast 12. Onboard forecasting allows for more frequent forecasting as the data 22 can be gathered in real time and the forecasts 12 are preferably produced continually. If forecasting suggests a large enough adverse event 18, GOES-R 10 may be pre-programmed to enter into safety mode 64 to protect sensitive hardware/software. It should be noted that this satellite 10 is designed to continually monitor the Sun and a safety mode turning off all the instruments is unlikely. The forecasts 12 may also be disseminated to a ground station 66 and/or nearby spacecraft 30 for risk-mitigation purposes. The forecasts 12 cover the most impactful of space weather events 18: X-ray events (solar flares), particle events (radiation), and CMEs (geomagnetically induced currents (GICs)).

A general flow chart illustrating the exemplary embodiment discussed above is shown in FIG. 4A. As can be seen, data 22 collected from onboard sensors 16 is initially stored in memory 24, on a hard disk or otherwise as desired, until downloaded to a receiving station 66 on Earth and is preferably erased after detection algorithms 36 have been performed to create the necessary metadata 62 desired for forecasting. This helps to minimize both onboard memory 24 requirements as well as minimizing power usage and weight associated with such systems. After data 22 from measurements performed by the desired detection equipment 16 has been gathered, it is stored and preferably also transmitted to another remote location or device 30. Onboard automatic detection algorithms 36 are then employed to create the desired metadata 62. This onboard metadata 62 is preferably temporarily stored for use in the desired forecasting model or models 28. Additionally, this metadata 62 is also preferably transmitted via the onboard transceivers 54 or other downlinks to remote or ground based locations 66. This allows for forecast verifications 68 based on common data 22, 62 as both the in-situ automatic detection algorithms 36 and the ground based automatic detection algorithms run on the same data 22, 62 and the output metadata can then be compared. This will help to improve risk mitigation procedures at both locations.

Multiple forecasting models 28 can be run if the end-user or system 10 desires a variety of space weather predictions or forecasts 12 in order to achieve the best risk mitigation. Subsequently, the forecasts 12 are created and may be utilized in preferably automated risk mitigation efforts onboard the spacecraft 10. For example, an adverse forecast 12 can prompt an automatic equipment reaction, such as prompting a thruster 72 to reposition the spacecraft 10 or prompting sensitive equipment to enter a safe mode 64, or an automated alert 70 can be generated by the computer 20 to indicate steps to be taken to protect sensitive equipment or crew. Additionally, the created forecast(s) 12 can be sent to other spacecraft 30 or ground based operations 66 as desired.

It should also be noted that this example focuses strictly on a spacecraft implementation. However, there may be the possibility of having the same system run wherever provided that it is in the necessary environment (measurements) to predict a natural event. For instance, algorithms could be run at PJM power grid stations that measure GICs. GIC events combined with forecasts disseminated by GOES may give the grid industry better risk-mitigation procedures. As another example, if you have a colony on Mars, you would want the forecast system on the ground as well onboard a satellite orbiting Mars.

A general description of the present invention as well as a preferred embodiment of the present invention has been set forth above. Those skilled in the art to which the present invention pertains will recognize and be able to practice additional variations in the methods and systems described which fall within the teachings of this invention. Accordingly, all such modifications and additions are deemed to be within the scope of the invention which is to be limited only by the claims appended hereto.

What is claimed is:

1. A system for in-situ forecasting, the system comprising:
a. a first vehicle including a measuring device recording weather data correlating to an external environmental condition of interest;
b. a storage device on the first vehicle in which the weather data is received, the storage device being operatively connected to the measuring device;
c. a processor on the first vehicle, the processor operatively connected to the storage device, the processor accessing an automatic detection algorithm to generate environmental event condition data to be stored on the storage device;
d. a forecast algorithm accessed by the processor wherein the processor accesses the environmental event condition data for use in the forecast algorithm;
e. a forecast created by the processor, the processor accessing the forecast algorithm and wherein the forecast is stored on the storage device; and
f. a risk mitigation instruction created by the processor wherein the risk mitigation instruction in based on the forecast.

2. The system of claim 1 further comprising a transceiver on the first vehicle.

3. The system of claim 2 further comprising a second vehicle in communication with the first vehicle.

4. The system of claim 3 further comprising a copy of the risk mitigation instruction on the second vehicle.

5. The system of claim 2 further comprising a ground station and a copy of the weather data sent to the ground station through the transceiver.

6. The system of claim 5 further comprising a second forecast created at the ground station, the second forecast based on the same data used by the first vehicle to create the forecast.

7. The system of claim 6 further comprising a verification event wherein the forecast is compared to the second forecast.

8. The system of claim 1 wherein the vehicle is a satellite and/or spacecraft.

9. The system of claim 1 wherein the vehicle is an aircraft.

10. A system including on board forecasting of adverse weather events, the system comprising:
a. a first vehicle;
b. a detector on the first vehicle;
c. data created by the detector in response to an external weather condition;
d. a computer on the first vehicle, the computer including:
i. a processor accessing the data;
ii. a forecast created on the vehicle, the forecast based on the data;
iii. an adverse weather condition prediction created by the forecast;
iv. a risk mitigation instruction; and
e. a transceiver on the first vehicle.

11. The system of claim 10 further comprising a second vehicle, wherein the second vehicle includes a transceiver in communication with the transceiver on the first vehicle.

12. The system of claim 11 further comprising a copy of the risk mitigation instruction from the first vehicle, the copy of the risk mitigation instruction on the second vehicle.

13. The system of claim 10 further including a ground station, the ground station in communication with the first vehicle.

14. The system of claim 13 further comprising a copy of the data, the data copy being located at the ground station.

15. The system of claim 14 wherein the ground station receives the data copy and creates a ground station forecast.

16. The system of claim 15 wherein the ground station forecast is compared to the forecast on the first vehicle.

17. The system of claim 10 wherein the detector is an imager.

18. The system of claim 10 wherein the detector is a particle sensor.

19. The system of claim 10 wherein the detector is a magnetometer.

20. A method of in-situ mitigation of environmental weather risks, the method comprising:
a. Providing a first vehicle with a detector, a storage device, a computer and a transceiver;
b. Receiving data from the detector;
c. Storing the data received from the detector;
d. Transmitting the data from the detector to a ground station;
e. Running an automatic detection algorithm based on the data, the automatic detection algorithm being located on the computer;
f. Creating a first forecast on the computer, the forecast based on the data;
g. Creating a second forecast at a remote location based on the data;
h. Comparing the first forecast with the second forecast for verification;
i. Using the forecast to create a prediction of an adverse weather event;
j. Creating a risk mitigation instruction based on the prediction; and
k. Sharing the risk mitigation instruction with a second vehicle.
